(19) United States
(12) Patent Application Publication
(10) Pub. No.: US 2009/0031619 A1
(43) Pub. Date: Feb. 5, 2009

(54) Solid Fuel

(76) Inventors: Elyakim Maman, Avtalion (IL); Yuval Segner, Avtalion (IL)

Correspondence Address: ROBERT G. LEV, 4766 MICHIGAN BLVD., YOUNGSTOWN, OH, 44505, US

(21) Appl. No.: 12/087,564

(22) PCT Filed: Dec. 21, 2006
(86) PCT No.: PCT/IL06/01471

§ 371 Date: Jul. 7, 2008

(30) Foreign Application Priority Data
Jan. 5, 2006 (IL) IL 172991

(51) Int. Cl. C10L 5/14

(52) U.S. Cl. 44/555; 44/577

(57) ABSTRACT

A firewood substitute comprising olive waste and organic binder.

### PRIORITY INFORMATION

The present invention claims priority to PCT Application No: PCT/IL2006/001471, filed Dec. 21, 2006, and to Israeli Patent Application No: IL172991, filed Jan. 5, 2006.

### FIELD OF THE INVENTION

The present invention is directed to providing a solid fuel for domestic heating, and particularly to a solid fuel based on the by-products of the olive oil industry.

### BACKGROUND

Olive oil is regarded as a high quality foodstuff. It is used in salad dressings, for frying and baking. It also finds use as additives in cosmetics and the like. The process of making olive oil requires the squeezing of olives. The squeezed kernels and pits, henceforth olive waste, is a byproduct that finds limited use in bovine fodder and composting, but is often simply discarded as landfill.

International Patent Publication Number WO0718397 describes usage of olive waste as an additive to compost. U.S. Pat. No. 6,814,940 describes usage of organic waste, including olive waste for production of biogas.

In Mediterranean countries, olive waste has long been used as a fuel in domestic stoves. Indeed, olive oil was much cherished in oil lamps for lighting purposes. Olive waste is, however, dirty and oily.

There have been attempts to make faggots from olive waste. For example, Greek Patent Number GR1001590B to Potis Anastasios describes a method of production of firewood from olive kernels. Specifically, the invention relates to the production of firewood in cylindrical pieces of standard dimensions (f=50/63/75 mm) which can be used as a fuel. The firewood is produced from olive kernels. Following processing in olive presses the olive kernels are processed in the following sequence: From the storage silo they are transported to a vibrating separator fitted with magnets, where foreign material is removed; they are then conveyed by a screw feeder where mixing with water (until a moisture content of 12-14% is achieved) to a cylindrical press where the amorphous fleshy and wood like components of the kernels are compressed into compact and cohesive cylinders of a diameter of 8/10/12 mm and of length between 0.5 and 2 cm. Following compression, the cylinders are coolled (until they reach the ambient temperature) and they are transported to a horizontal reciprocating press operating continuously, where the firewood pieces are produced. These pieces are then cooled by blowing cool air along their route towards a cutter, where they are cut to the desired length. Following cutting the firewood pieces are ready for packaging. The firewood produced is a natural product, with ecological properties, a high calorific value of 5025 kcal/kg, and a uniform moisture content. These properties make it suitable for use in fireplaces, stoves, traditional ovens, barbecues, etc.

Greek Patent Application Number GR2100462A to Makaronas Nikolaos relates to a method for the production of artificial firewood derived from olive stones. To the olive stone a small quantity of shavings, peelings of dried fruit, gorse, thyme and, in general, meadow grasses are added to give the product the form, colour and fragrance of wood. For the easy lighting thereof, paraffin-oil or other oil derivatives can be added. By exploiting useless and unexploited products, an economical, ecological product exhibiting great heat energy, and appearance similar to the common firewood may be obtained.

The present invention relates to improved firewood substitutes, henceforth faggots, that are made from olive waste with novel additives, providing new properties, and a narrow patent is requested in this crowded field.

### SUMMARY OF THE INVENTION

It is an aim of the invention to make use of the waste products of the olive oil industry.

It is a further aim of the invention to be environmentally friendly, by minimizing landfill from the waste-products of olive oil production, and to produce a firewood substitute that burns with a pleasant smell, without releasing noxious fumes or dangerous molecules.

It is a specific aim of the invention to produce a firewood substitute that is easy to handle.

It is a particular aim of preferred embodiments to utilize waste products of the carpentry industry to further improve the firewood substitute.

In a first aspect, the present invention is directed to providing a firewood substitute comprising olive waste and organic binder.

Typically, the firewood substitute includes both olive seeds and fibrous waste from squeezed olives.

Optionally, the organic binder comprises a starch such as potato starch or corn starch.

Alternatively, the organic binder comprises agar or gelatin.

In preferred embodiments, the firewood substitute further comprises wood particles, such as saw dust or wood shavings.

In most preferred embodiments the wood particles include particles of resinous woods, such as pine or maple.

In a second aspect, the present invention is directed to a method of manufacturing a firewood substitute comprising the steps of:
(a) separating liquid and solid elements of olives to produce solid olive waste;
(c) mixing solid olive waste with organic binder solution;
(e) forming faggots, and
(f) drying the faggots.

Preferably, step (a) of separating liquid and solid elements of olives to produce solid olive waste occurs in the process of extracting olive oil and the solid elements are a byproduct of the olive oil extraction process.

Typically, the organic binder comprises a starch solution comprises starch selected from the list of potato starch and corn starch.

Alternatively, the organic binder comprises a binder selected from the list of agar and gelatin.

Optionally the process comprises an additional step (b) or (d) of adding wood particles.

Typically the wood particles are the byproducts of carpentry.

Preferably the wood particles are saw dust, wood shavings or chippings.

Most preferably the wood particles comprise resinous wood particles, such as pine or maple for example.

Optionally the step of forming faggots comprises extruding a green material as a sludge.

Alternatively, the step of forming faggots comprises pressing a green material into molds.

Optionally step (e) of drying the faggots comprises drying naturally.

Alternatively, step (e) of drying the faggots comprises drying by forced convection.

Alternatively, step (e) of drying the faggots comprises heating the faggots to drive off surplus moisture.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic illustration of a system for producing faggots of firewood substitute in accordance with one embodiment of the present invention;

FIG. 2 is a schematic illustration of a faggot produced by the system of FIG. 1, and

FIG. 3 is a flow chart illustrating the steps of production of firewood substitute in accordance with the present invention.

### DESCRIPTION OF THE PREFERRED EMBODIMENTS

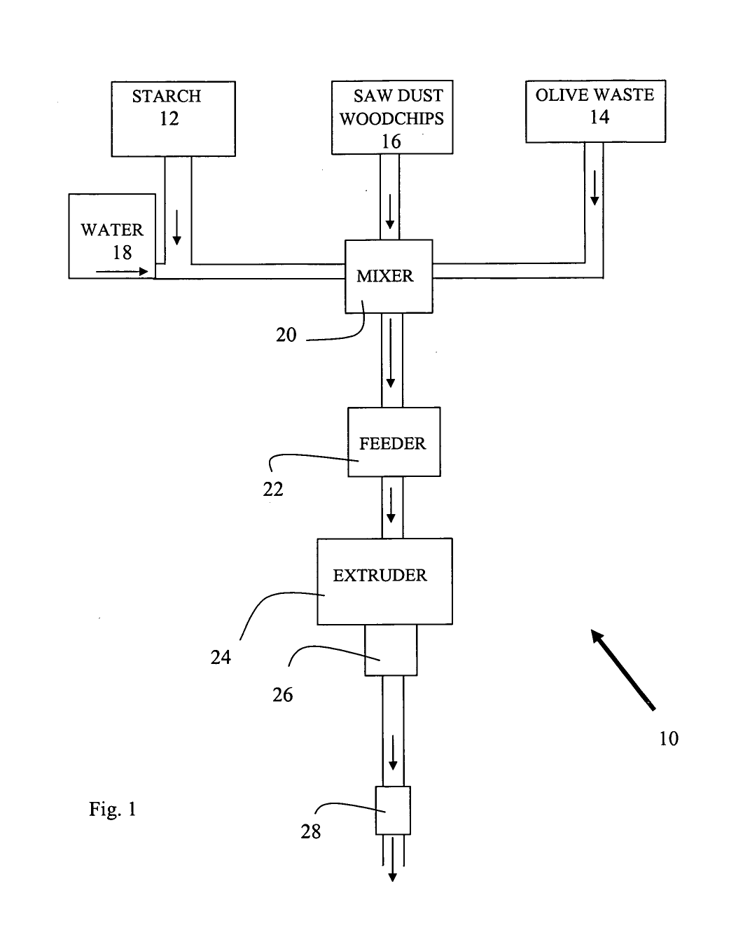

With reference now to FIG. 1, a processing plant 10 for producing a firewood substitute in accordance with one embodiment of the present invention is schematically shown. The plant 10 consists of reservoirs of starch 12, olive waste 14 and wood particles 16. The reservoirs are typically hoppers. The olive waste 14 may include both olive seeds and fibrous waste from squeezed olives, and is typically the waste product from oil presses used to manufacture olive oil.

The wood particles 16 in wood particle reservoir are typically the waste product from the timber or carpentry industry. Although other woods may be used, preferably the wood particles include particles of resinous woods, such as pine and maple saw dust and shavings. Pine and maple are standard timbers used in furniture manufacturing and are readily available. Both these timbers contain sticky saps having pleasant odors, and saw dust, wood shavings and chippings from pine and maple have been found to be particularly useful ingredients in the faggots of the present invention.

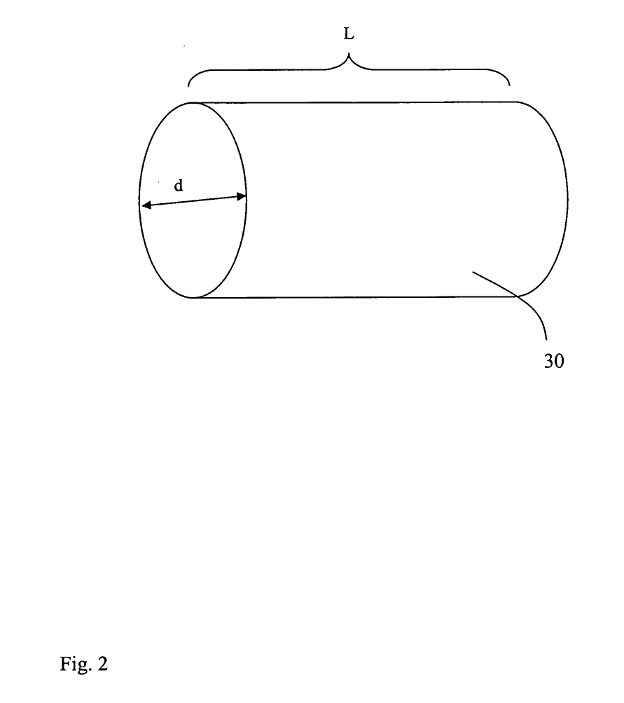

Water 18 is added to dissolve the starch 12 and the starch solution/suspension is mixed with the olive waste 14 and wood particles 16 in a mixer 20. The mixed sludge flows into a feeder 22, from which the sludge is pumped into an extruder 24 for extrusion through a nozzle 26 into a preliminary drier 28 to produce a continuous green extrusion which may be cut into green faggots 30 (FIG. 2) for subsequent drying.

With reference to FIG. 2 a schematic illustration of an exemplary faggot 30 produced by the system 10 of FIG. 1 is shown. The diameter d of the faggot depends on the diameter of the nozzle 26 (FIG. 1) of the extruder 24. The length l of the faggot depends on the frequency with which the extruded sludge is cut, and on the rate of extrusion. Such faggots can be cylinders of any size and aspect ratio. Furthermore, the nozzle 26 need not be circular, and the extruded faggots may not be cylindrical and may rather have other cross sectional shapes. Indeed, in alternative embodiments faggots of the invention may be produced in molds, and may have rectangular, brick shapes, for example.

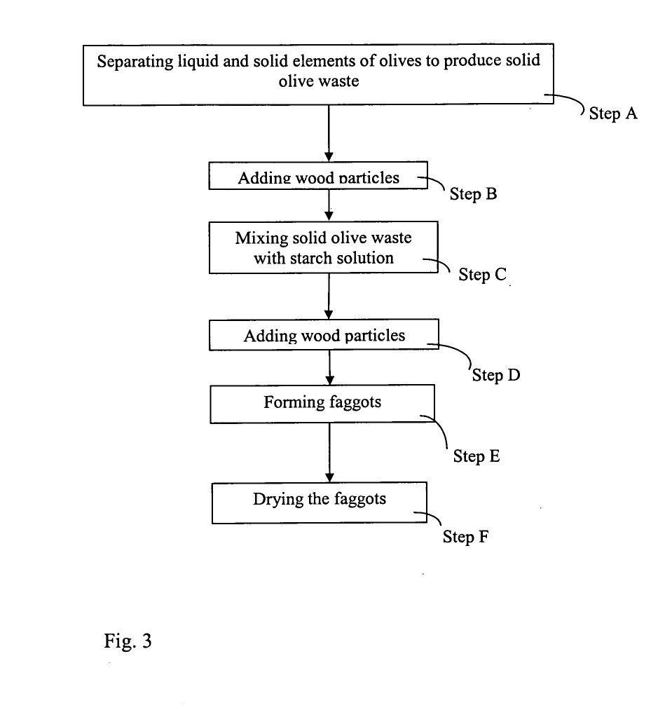

With reference to FIG. 3, a flow chart illustrating the method of production of firewood substitute in accordance with the present invention is shown.

The method of manufacturing a firewood substitute comprising the steps of: separating liquid and solid elements of olives to produce solid olive waste—step (a). This typically occurs in the process of extracting olive oil, the solid elements being a byproduct of the olive oil extraction process. Then wood particles may be added to the olive waste—step (b). Wood particles may be byproducts of the timber industry, of carpentry or cabinet making, and may be saw dust, wood shavings or chips, including wood particles of different sizes and shapes. Wood particles may also be from any trees, but woods that release poisonous, carcinogenic or noxious gases and smoke particles are best avoided, and preferably woods are used that have pleasant fragrances when burnt. Most preferably, the wood particles include pine or maple particles. Pine and maple are commonly used timbers, and the sap of these trees is sticky and pleasantly fragranced. Next, a starch solution, based on potato starch or corn starch, for example, may be added—step (c). The wood particles may be added after the starch, to the olive waste and starch mixture—step (d). Indeed, in some embodiments, wood particles are not added at all. The resulting sludge is formed into faggots, by extrusion for example, or by casting the green material in molds—Step (e). The faggots are then dried—step (f). Drying step (f) may include drying naturally, accelerated drying by forced convection, or by heating the faggots to drive off surplus moisture in a drying oven, for example.

It will be appreciated that the recipe and process described hereinabove may be varied somewhat. Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A firewood substitute comprising olive waste and organic binder.

2. The firewood substitute of claim 1 comprising both olive seeds and fibrous waste from squeezed olives.

3. The firewood substitute of claim 1, said binder comprising a starch selected from the list of potato starch and corn starch.

4. The firewood substitute of claim 1, said organic binder comprising at least one of the list of agar, gelatin and starch.

5. The firewood substitute of claim 1, further comprising wood particles.

6. The firewood substitute of claim 5, said wood particles being selected from the list of saw dust, wood shavings and chippings.

7. The firewood substitute of claim 5, said wood particles comprising particles of resinous woods.

8. The firewood substitute of claim 7, said resinous woods being selected from the list of pine and maple.

9. A method of manufacturing a firewood substitute comprising the steps of:
(a) separating liquid and solid elements of olives to produce solid olive waste;
(c) mixing solid olive waste with organic binder solution;
(e) forming faggots, and
(f) drying the faggots.

10. The method of claim 8, wherein step (a) of separating liquid and solid elements of olives to produce solid olive waste occurs in a process of extracting olive oil and the solid elements are a byproduct of the olive oil extraction process.

11. The method of claim 9, said organic binder solution comprising a starch selected from the list of potato starch and corn starch.

12. The method of claim 9, said organic binder solution comprising at least one of the list of agar, gelatin and starch.

13. The method of claim 9, further comprising an additional step (b) or (d) of adding wood particles.

14. The method of claim 13, the wood particles comprising the byproducts of carpentry.

15. The method of claim 13, the wood particles comprising saw dust, wood shavings or chippings.

16. The method of claim 13, the wood particles comprising resinous wood particles.

17. The method of claim 16, the wood particles comprising pine or maple particles.

18. The method of claim 9, wherein the step of forming faggots comprises extruding a green material as a sludge.

19. The method of claim 9, wherein the step of forming faggots comprises pressing a green material into molds.

20. The method of claim 9, wherein step (e) of drying the faggots comprises. a method selected from the group of: drying naturally, drying by forced convection, and heating the faggots to drive off surplus moisture.

21. (canceled)

22. (canceled)

23. (canceled)

24. (canceled)
